(19) United States
(12) Patent Application Publication
(10) Pub. No.: US 2018/0250836 A1
(43) Pub. Date: Sep. 6, 2018

(54) Folding Knife having an Adjustable/Removable Thumb Stud

(71) Applicant: Richard D. Hinderer, Shreve, OH (US)

(72) Inventor: Richard D. Hinderer, Shreve, OH (US)

(21) Appl. No.: 15/907,997

(22) Filed: Feb. 28, 2018

Related U.S. Application Data
(60) Provisional application No. 62/466,216, filed on Mar. 2, 2017.

(51) Int. Cl. B26B 1/06

(52) U.S. Cl. CPC B26B 1/06

(57) ABSTRACT

The folding knife includes a removable thumb stud slidably mounted on the blade to be selectively positioned along the length of the blade's spine. The thumb stud includes a flat button head and a pair of spaced legs that terminate with an in-turned foot. The blade has a channel cut into the flats on both sides of the blade, which act as tracks for the thumb stud. The opposed feet shiftably seat within the channels and allow the thumb stud to be selectively positioned along the length of the blade spine.

This application claims the benefit of U.S. Provisional Application No. 62/466,216 filed Mar. 2, 2017, the disclosure of which is hereby incorporated by reference.

This invention relates to folding knives and in particular folding knives having an adjustable/removable thumb stud.

### BACKGROUND AND SUMMARY OF THE INVENTION

In traditional “slip joint” style folding knifes, the pivoting blade is not “locked” in either the open or closed position, but held in place by tension from a flat bar or leaf type back spring that allows the blade to fold up or out under application of a certain amount of manual force. Folding knives often use thumb studs mounted to the blade or small curved grooves cut into the side of the blade (commonly referred as “nail nicks”) to help users apply the manual opening force to folding knives, particularly slip joint style folders. One drawback for folding knives and particularly slip joint style folders, is the leverage required to open the blade in a one handed operation. Hand sizes and grips vary amongst users, but heretofore thumb studs and nail nicks have fixed locations on the blade. Consequently, the location of the thumb stud or nail nick may not be optimally located along the blade for ease of opening for any particular user.

The present invention provides an adjustable/removable thumb stud that can be selectively positioned along the spine of the blade. In an exemplary embodiment of this invention as a “slip joint” style folder, the knife includes a removable thumb stud slidably mounted on the blade to be selectively positioned along the length of the blade's spine. The thumb stud includes a flat button head and a pair of space legs that terminate with an in-turned foot. The blade has a channel cut into the flats on both sides of the blade, which act as tracks for the thumb stud. The opposed feet shiftably seat within the channels and allow the thumb stud to be selectively positioned along the length of the blade spine. The thumb stud is secured to the blade and held in position along the blade spine by a screw. Users can selectively position the thumb stub along the blade spine at the optimal position for leveraging the blade to the open position. One end of each channels is machined to form an entry opening that allows the thumb stud to be removed from the blade. The knife also uses an internal stop pin mounted between the handle sides that extends laterally through an arcuate slot cut into the tang of the blade around the pivot pin to limit the travel of the blade between its open and closed positions.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the folding knife of this invention;

FIG. 2 is an exploded view of the folding knife of FIG. 1;

FIG. 3 is a partial exploded view of the blade and adjustable/removable thumb stud of the knife of FIG. 1;

FIG. 4 is a side sectional view of the knife of FIG. 1 in the open position;

FIG. 5 is a side sectional view of the knife of FIG. 1 in the closed position;

FIG. 6 is a partial side sectional view of the knife of FIG. 1 showing the thumb stud at one position along the blade channel; and

FIG. 7 is a partial side sectional view of the knife of FIG. 1 showing the thumb stud at another position along the blade channel.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

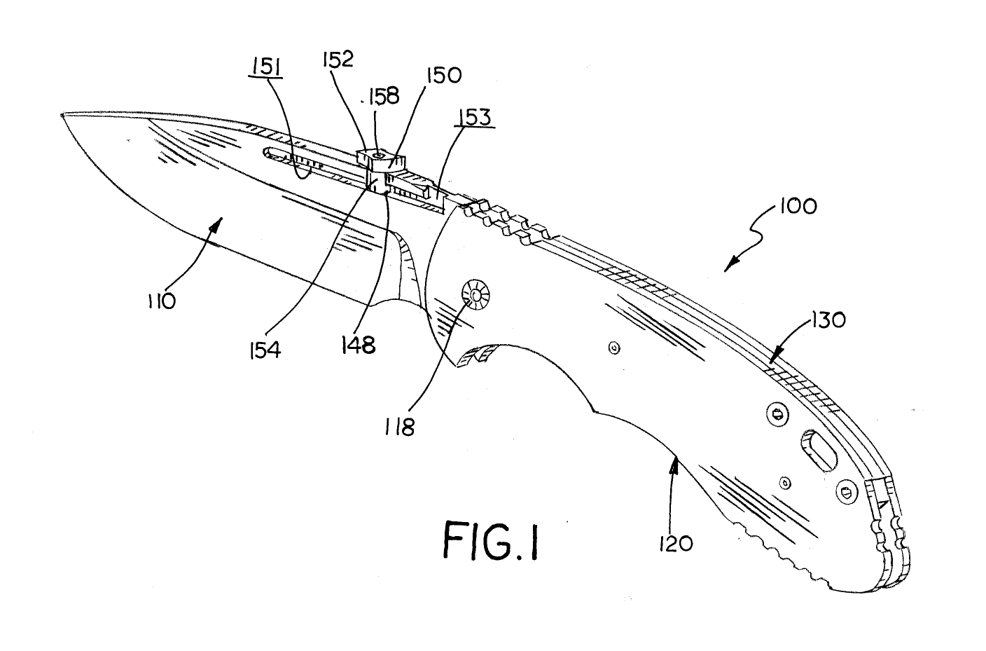

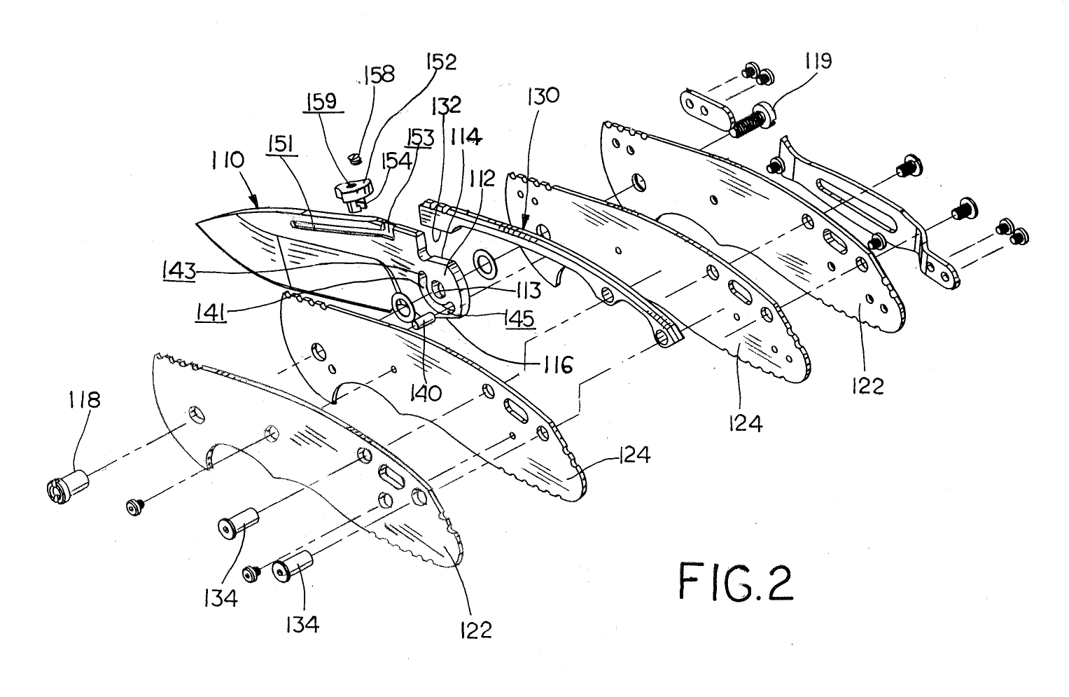

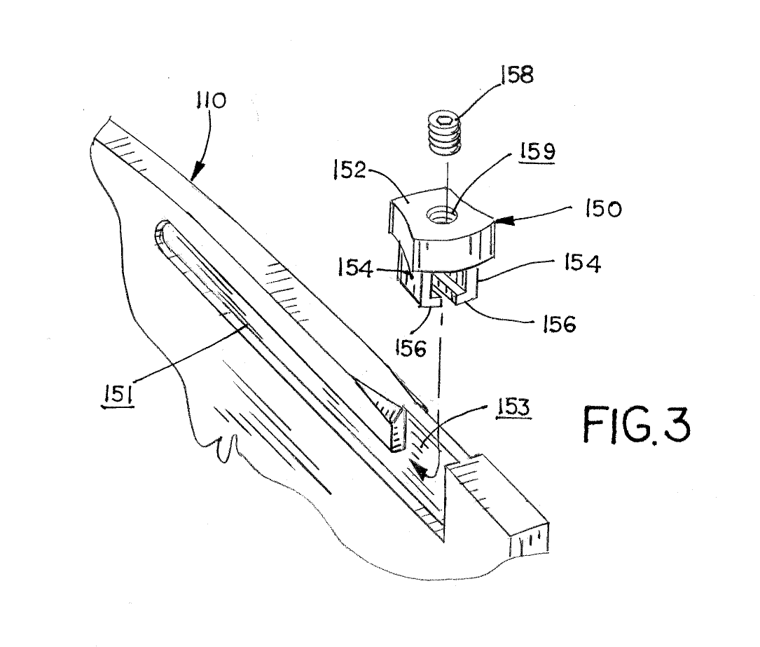

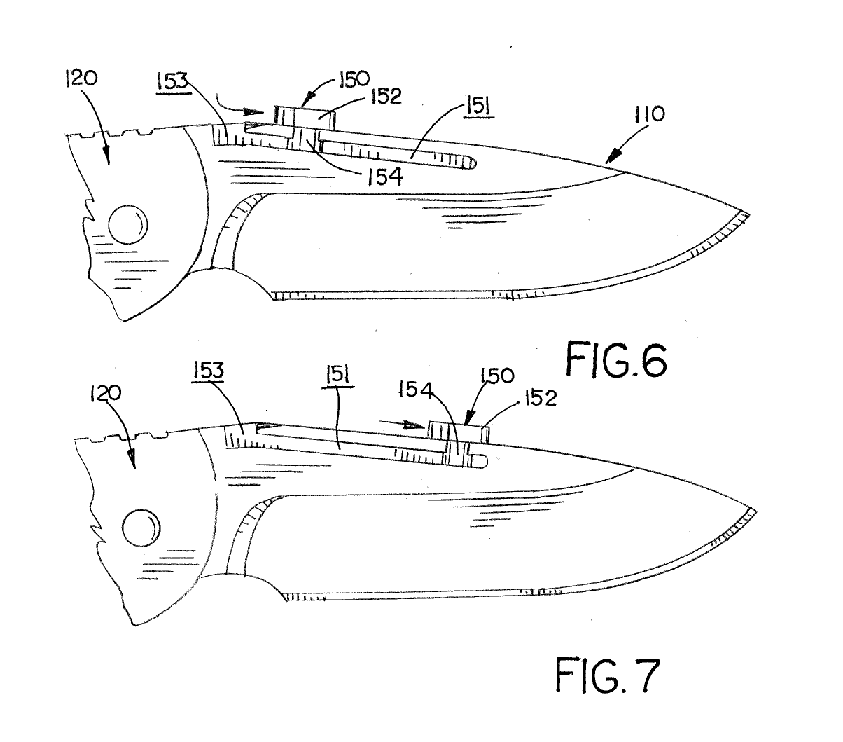

Referring now to the drawings, FIGS. 1-7 illustrate an exemplary embodiment of a folding knife of this invention, which is designated generally as reference numeral 100. As shown, knife 100 is illustrated as a “slip joint” style folder, although the teaching of this invention may be readily applied to other styles of folding knives, including but not limited to “lock-back,” “liner lock” and “frame-lock” style knives and may be modified within the teachings of the present invention. For ease of explanation, many commonly known features of folding knives are omitted in the figures and description of embodiments of the invention. For example, handle construction using various spacers, liners, scales, pins and fasteners are well known in the art and need not be discussed in detail. In addition, the grind and blade style may vary without deviating from the teachings of this invention.

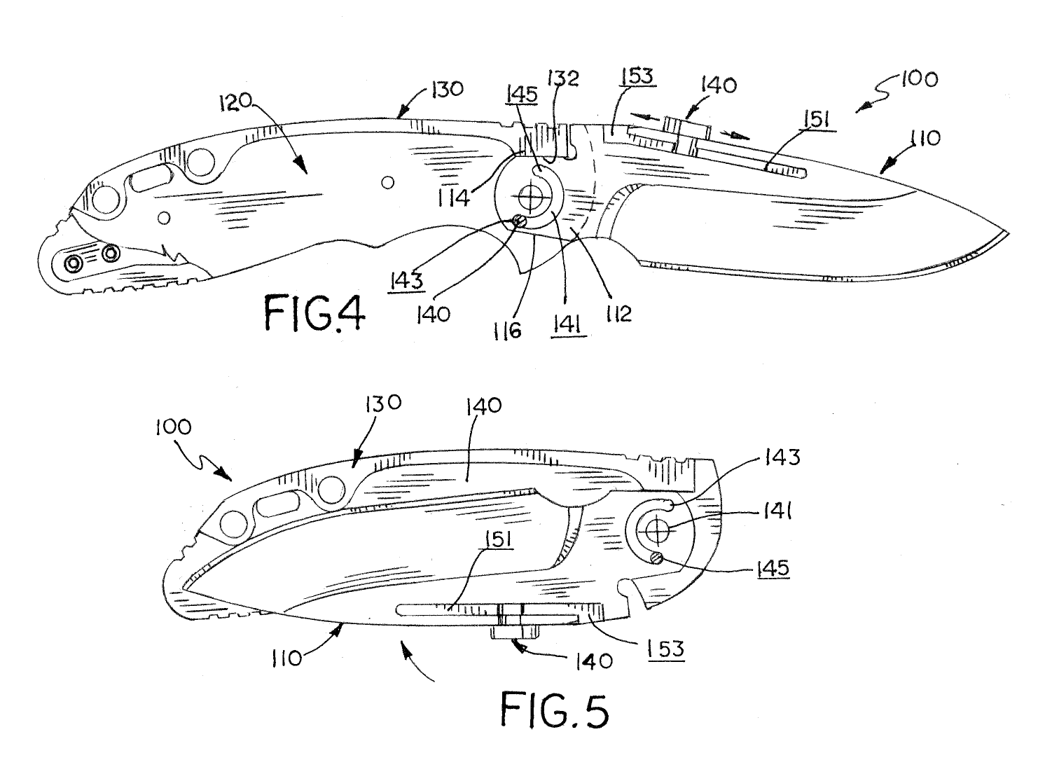

Knife 100 includes a blade 110 pivotally coupled to a handle 120 for rotation between an open position (FIG. 4) and a closed position (FIG. 5) and flat bar or leaf-type backspring 130 that holds the blades in the open position. Handle 120 consists of a pair of side members that are spaced apart to form an area 121 for receiving blade 110 therein in the closed position. Each handle side member (left and right sides) includes outer scale 122 and inner liner 124. Scales 122 may be constructed of any suitable material, including metals, plastics, resin based laminates and other composite materials. Liners 124 are stamped or cut from sheets of metal, such as aluminum, steel or titanium. Blade 110 is typically constructed from metals or other material suitable for use in cutting blades and may be ground in any desired blade configuration. Blade 110 has a tang 112 with two flat edges 114 and 116 for engaging the backspring 130. Blade 110 is pivotally connected to handle 120 by a two piece pivot pin (consisting of a pivot barrel 118 and lock screw 119). Blade 110 pivots axially about the pivot pin, which extends through a pivot bore 113 in tang 112. Backspring 130 is generally constructed from a resilient metal and has an elongated body with a flat contact surface 132 configured to engage the flat edge 114 and 116 of blade tang 122. Backspring 130 is positioned between handle halves and secured within handle 120 by pins 134.

Blade 110 does not lock but, once opened, is held in place by tension from backspring 130 that allows the blade to fold if a certain amount of pressure is applied. Contract surface 132 bears against the back edge of blade tang 112 and seats flat against flat edges 114 and 116 in the open and closed positions. Unlike conventional folders, particularly “slip joint” style folders, where the travel of the blade is limited by the blade tang physically abutting against the backspring or handle, knife 100 uses a stop pin 140 seated within an arcuate slot 141 cut into tang 112 around the pivot pin 122. Stop pin 140 is fitted between the handle halves and extends laterally through slot 141. As blade 110 moves between the open and closed position, stop pin 140 slides through slot 141 between opposed ends 143 and 145 of the slot. Stop pin 140 abuts end 143 to limit the travel of blade 110 at the open position (FIG. 4) and slot end 145 to limit the travel of the blade at the closed position (FIG. 5).

Knife 100 also includes a removable thumb stud 150 that is shiftably mounted to blade 110 to be selectively positioned along the length of the blade's spine. Thumb stud 150 includes a flat head or disc 152 and a pair of space legs 154 that extend downward from the head. Legs 154 are spaced parallel to each other to form a channel for receiving blade 110. Each leg 154 terminates with an in-turned foot 156, so that the feet face each other. As shown, blade 110 has a channel 151 cut into the flats on both sides of the blade. Channel 151 is spaced from and extends parallel to the spine of blade. Channels 151 act as a track for thumb stud 150. The opposed feet 156 shiftably seat within channels 151, which allows thumb stud 150 to be selectively positioned along the length of the blade spine. Thumb stud 150 is secured to blade 110 and held in position along the blade spine by a locking or set screw 158, which is turned into a threaded bore 159 in head 152 to engage the blade spine. Users can selectively position the thumb stub along the blade spine at the optimal position for leveraging the blade to the open position. One end of channels 151 is machined or otherwise formed to open to the edge of the blade spine forming an entry opening 153. Entry opening 153 allows thumb disc 150 to be completely removed from blade 110 if desired.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1: A folding knife comprising:
a handle having two spaced side members;
a blade pivotally connected to the handle between the two side members for rotational movement between an open position where the blade is extended from the pair of handle sides and closed position where the blade is interposed between the pair of handle sides, the blade having a blade tang, a blade spine and opposed blade sides thereof; and
a removable thumb stud slidably mounted to the blade for movement along the length of the blade spine.

2: The knife of claim 1 wherein the thumb stud includes a fastener turned into a threaded bore in the thumb stub and engaging the blade to secure the thumb stud to the blade in place along the length of the blade spine.

3: The knife of claim 1 the thumb stud includes a head part and a pair of spaced legs extending from the head part, the blade spine interposed between the pair of spaced legs.

4: The knife of claim 3 wherein the blade also having an elongate recessed channel formed in at least one of the blade sides parallel to the blade spine.

5: The knife of claim 4 wherein at least one of the pair of spaced legs terminates in a foot seated within the channel.

6: The knife of claim 3 wherein the channel terminates at one end thereof in an end opening extending to the blade spine, the end opening constituting a passage for removing the thumb stub from the blade.
